(19) United States
(12) Patent Application Publication
(10) Pub. No.: US 2026/0268793 A1
(43) Pub. Date: Sep. 10, 2026

(54) VEHICULAR SYSTEM FOR DETECTING AND REPORTING UNSAFE NON-DRIVING BEHAVIORS

(71) Applicant: TOYOTA MOTOR ENGINEERING & MANUFACTURING NORTH AMERICA, INC., Plano, TX (US)

(72) Inventors: Michael R. Koch, Milford, MI (US); Dae Yoo, South Lyon, MI (US)

(73) Assignees: TOYOTA MOTOR ENGINEERING & MANUFACTURING NORTH AMERICA, INC., Plano, TX (US); TOYOTA JIDOSHA KABUSHIKI KAISHA, Aichi-ken (JP)

(21) Appl. No.: 19/070,446

(22) Filed: Mar. 4, 2025

(51) Int. Cl. G09B 19/00; B60G 17/019; B60N 2/00; B60Q 9/00

(52) U.S. Cl. CPC G09B 19/00; B60G 17/019; B60N 2/0021; B60Q 9/00; B60G 2401/14; B60G 2401/21

(57) ABSTRACT

A vehicle occupant behavior monitoring system includes the vehicle, at least one sensor, and a processor comprising a memory. The processor is configured to: with the at least one sensor, capture first information about a prohibited non-driving behavior of an occupant of the vehicle; based on the captured first information, determine a first severity of the prohibited non-driving behavior; based on the prohibited non-driving behavior and the determined first severity, automatically initiate a curtailment action, where a magnitude of the curtailment action is based on the determined first severity; with the at least one sensor, capture second information about the prohibited non-driving behavior of the occupant of the vehicle; based on the captured second information, determine a second severity of the prohibited non-driving behavior; and based on the second severity, adjust the magnitude of the curtailment action.

### TECHNICAL FIELD

The subject matter described herein relates generally to improving the safety of a vehicle's occupants and, more particularly, to apparatus, systems, and methods for monitoring, responding to, and reporting the behavior of vehicle occupants. This technology has particular but not exclusive utility for consumer cars and trucks.

### BACKGROUND

It is common for vehicles to provide cautionary feedback to a driver, such as seatbelt notifications, “door ajar” warnings, etc. Further, it is known in the prior art to provide cautionary feedback based on the way the driver is operating the vehicle. For example, a vehicle may provide artificial engine noises to drivers to bring their attention to the speed at which their vehicle is driving. However, many non-driving behaviors can affect the safety of vehicle occupants while the vehicle is running. For purposes of this disclosure, non-driving behaviors may be defined as behaviors not directly related to the operation of the vehicle, as opposed to driving behaviors such as steering, braking, accelerating, navigation, operating turn signals and windshield wipers, etc.

The information included in this Background section of the specification is included for technical reference purposes only and is not to be regarded as subject matter by which the scope of the disclosure is to be bound.

### SUMMARY

The behavior of vehicle occupants can have significant safety implications, and can vary significantly in different circumstances. For example, when a teenage driver is operating a vehicle, circumstances such as loud noise or music, yelling/cursing, prohibited passengers, smoking/vaping, throwing objects, fighting/jostling, and intimate acts can all contribute to driver distraction and thus create an unsafe driving condition. Disclosed herein is a vehicle occupant behavior monitoring system, capable of detecting prohibited behaviors, automatically initiating curtailment actions, and reporting to a parent or guardian. The vehicle occupant behavior monitoring system has particular, but not exclusive, utility for improving the safety of consumer cars and trucks.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a vehicle occupant behavior monitoring system. The vehicle occupant behavior monitoring system includes the vehicle. The system also includes at least one sensor. The system also includes a processor including a memory and configured to: with the at least one sensor, capture first information about a prohibited non-driving behavior of an occupant of the vehicle; based on the captured first information, determine a first severity of the prohibited non-driving behavior; based on the prohibited non-driving behavior and the determined first severity, automatically initiate a curtailment action, where a magnitude of the curtailment action is based on the determined first severity; with the at least one sensor, capture second information about the prohibited non-driving behavior of the occupant of the vehicle; based on the captured second information, determine a second severity of the prohibited non-driving behavior; and based on the second severity, adjust the magnitude of the curtailment action. Other embodiments of this aspect include corresponding computer systems, apparatus, and computer programs recorded on one or more computer storage devices, each configured to perform the actions of the methods.

Implementations may include one or more of the following features. In some embodiments, the processor is further configured to report the prohibited non-driving behavior, the determined first severity, or the determined second severity to a device operated by a parent or guardian of a driver of the vehicle. In some embodiments, automatically initiating a curtailment action requires first receiving an input from the parent or guardian of the driver of the vehicle regarding a relationship between severity of the prohibited non-driving behavior and magnitude of the curtailment action. In some embodiments, the at least one sensor may include a microphone, and the prohibited non-driving behavior may include loud music, loud noise, yelling, or cursing. In some embodiments, the at least one sensor may include a cabin camera or lidar or a seat weight sensor, and the prohibited non-driving behavior may include transporting a prohibited passenger. In some embodiments, the at least one sensor may include a driver monitoring system, a cabin camera or lidar, or a cabin air quality sensor, and the prohibited non-driving behavior may include smoking or vaping. In some embodiments, the at least one sensor may include a cabin camera or lidar or a driver monitoring system, and the prohibited non-driving behavior may include throwing objects. In some embodiments, the at least one sensor may include a cabin camera or lidar, a driver monitoring system, or a seat weight sensor, and the prohibited non-driving behavior may include fighting or jostling. The at least one sensor may include a cabin camera or lidar, a driver monitoring system, a seat weight sensor, or a microphone, and the prohibited non-driving behavior may include an intimate act, coercion, or duress. In some embodiments, the curtailment action may include at least one of reducing an estimated vehicle range, switching to an eco mode, generating an engine code, triggering seatbelt warnings, adjusting climate control, adjusting a video system, adjusting an audio system, adjusting a suspension of the vehicle, or generating false vehicle problem sounds. Implementations of the described techniques may include hardware, a method or process, or computer software on a computer-accessible medium.

One general aspect includes a computer-implemented method for monitoring vehicle occupant behavior. The computer-implemented method includes, with a processor including a memory: with at least one sensor, capturing first information about a prohibited non-driving behavior of an occupant of the vehicle; based on the captured first information, determining a first severity of the prohibited non-driving behavior; based on the prohibited non-driving behavior and the determined first severity, automatically initiating a curtailment action, where a magnitude of the curtailment action is based on the determined first severity; with the at least one sensor, capturing second information about the prohibited non-driving behavior of the occupant of the vehicle; based on the captured second information, determining a second severity of the prohibited non-driving behavior; and based on the second severity, adjusting the magnitude of the curtailment action. Other embodiments of this aspect include corresponding computer systems, apparatus, and computer programs recorded on one or more computer storage devices, each configured to perform the actions of the methods.

Implementations may include one or more of the following features. In some embodiments, the method further includes reporting the prohibited non-driving behavior, the determined first severity, or the determined second severity to a device operated by a parent or guardian of a driver of the vehicle. In some embodiments, automatically initiating a curtailment action requires first receiving an input from the parent or guardian of the driver of the vehicle regarding a relationship between severity of the prohibited non-driving behavior and magnitude of the curtailment action. In some embodiments, the at least one sensor may include a microphone, and the prohibited non-driving behavior may include loud music, loud noise, or cursing. In some embodiments, the at least one sensor may include a cabin camera or lidar or a seat weight sensor, and the prohibited non-driving behavior may include transporting a prohibited passenger. In some embodiments, the at least one sensor may include a driver monitoring system, a cabin camera or lidar, or a cabin air quality sensor, and the prohibited non-driving behavior may include smoking or vaping. In some embodiments, the at least one sensor may include a cabin camera or lidar or a driver monitoring system, and the prohibited non-driving behavior may include throwing objects. In some embodiments, the at least one sensor may include a cabin camera or lidar, a driver monitoring system, or a seat weight sensor, and the prohibited non-driving behavior may include fighting or jostling. In some embodiments, the at least one sensor may include a cabin camera or lidar, a driver monitoring system, a seat weight sensor, or a microphone, and the prohibited non-driving behavior may include an intimate act, coercion, or duress. In some embodiments, the curtailment action may include at least one of reducing an estimated vehicle range, switching to an eco mode, generating an engine code, triggering seatbelt warnings, adjusting climate control, adjusting a video system, adjusting an audio system, adjusting a suspension of the vehicle, or generating false vehicle problem sounds. Implementations of the described techniques may include hardware, a method or process, or computer software on a computer-accessible medium.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the vehicle occupant behavior monitoring system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a diagrammatic illustration of a vehicle including a vehicle occupant behavior monitoring system, in accordance with at least one embodiment of the present disclosure.

FIG. 2 is a diagrammatic illustration, in a block-diagram form, of at least a portion of the vehicle occupant behavior monitoring system of FIG. 1, in accordance with at least one embodiment of the present disclosure.

FIG. 3 is an exemplary diagrammatic illustration of the vehicle occupant behavior monitoring system embodied as a vehicle, in accordance with at least one embodiment of the present disclosure.

FIG. 4 is a schematic diagram of a processor circuit, in accordance with at least one embodiment of the present disclosure.

FIG. 5 is a graphical representation of at least a portion of an example vehicle occupant behavior monitoring system, in accordance with at least one embodiment of the present disclosure.

FIG. 6 is a is a graphical representation of at least a portion of an example vehicle occupant behavior monitoring system, in accordance with at least one embodiment of the present disclosure.

FIG. 7 is a pre-curtailment screen display for an example vehicle occupant behavior monitoring system, in accordance with at least one embodiment of the present disclosure.

FIG. 8 is a post-curtailment screen display for an example vehicle occupant behavior monitoring system, in accordance with at least one embodiment of the present disclosure.

FIG. 9 is a schematic, diagrammatic representation, in flow diagram form, of an example vehicle occupant behavior monitoring method, in accordance with at least one embodiment of the present disclosure.

FIG. 10 is a schematic, diagrammatic representation of a curse word detection and reporting subsystem of the vehicle occupant behavior monitoring system, in accordance with at least one embodiment of the present disclosure.

FIG. 11 is a schematic, diagrammatic representation of a smoking/vaping detection and reporting subsystem of the vehicle occupant behavior monitoring system, in accordance with at least one embodiment of the present disclosure.

### DETAILED DESCRIPTION

Disclosed herein is a vehicle occupant behavior monitoring system The behavior of vehicle occupants—particularly when a young or inexperienced driver is operating the vehicle—can have significant safety implications, and can vary significantly in different circumstances. For example, when a teenage driver is operating a vehicle, circumstances such as loud noise or music, yelling/cursing, prohibited passengers, smoking/vaping, throwing objects, fighting/jostling, and intimate acts can all contribute to driver distraction and thus create an unsafe driving condition. Disclosed herein is a vehicle occupant behavior monitoring system, a vehicle system capable of detecting prohibited behaviors, automatically initiating curtailment actions by adjusting the operation of vehicle systems (sound system, drive train electronic control unit (ECU), etc.), and reporting the behavior, the curtailment action, and the effectiveness of the curtailment action, to a parent or guardian (e.g., through a smartphone app). The vehicle occupant behavior monitoring system has particular, but not exclusive, utility for improving the safety of consumer cars and trucks.

The present disclosure aids substantially in ensuring the vehicle is safely operated, by improving the driver's awareness of unsafe non-driving behaviors, and improving the parent or guardian's awareness of the behavior of the driver and passengers. Implemented on a processor in communication with a variety of sensors, the vehicle occupant behavior monitoring system disclosed herein provides practical feedback to the driver and parent/guardian based on real-time conditions. This augmented awareness transforms a potentially dangerous situation into one where the driver receives feedback on or curtailment of their own behavior and that of other vehicle occupants. This benefit comes, without the normally routine need for the parent or guardian to directly monitor the behavior of vehicle occupants. This unconventional approach improves the functioning of the vehicle, by providing information needed to improve the non-driving habits of the vehicle's operator.

The vehicle occupant behavior monitoring system may be implemented as a process at least partially viewable on a display, and operated by a control process executing on a processor that accepts user inputs from the brake pedal and other control pedals, and that is in communication with one or more sensors. Certain outputs of the vehicle occupant behavior monitoring system may be printed, shown on a display, read aloud, or otherwise reported to users. In that regard, the control process performs certain specific operations in response to different inputs or selections made at different times, and/or in response to real-time or near-real-time sensor readings. Certain structures, functions, and operations of the processor, display, sensors, and user input systems are known in the art, while others are recited herein to enable novel features or aspects of the present disclosure with particularity.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. It is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

These descriptions are provided for exemplary purposes, and should not be considered to limit the scope of the vehicle occupant behavior monitoring system. Certain features may be added, removed, or modified without departing from the spirit of the claimed subject matter.

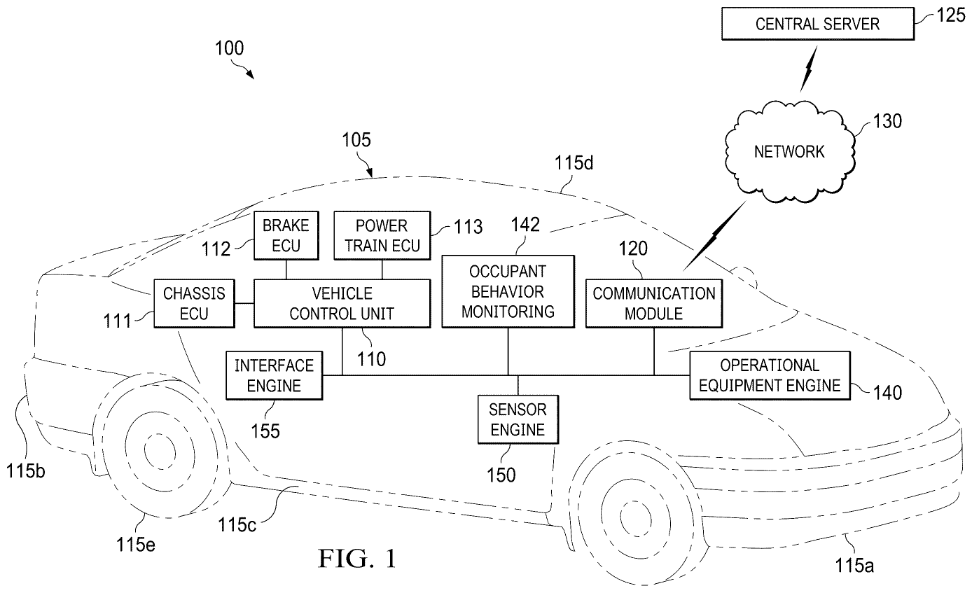

FIG. 1 is a diagrammatic illustration of a vehicle occupant behavior monitoring system in accordance with at least one embodiment of the present disclosure. In an example, a vehicle occupant behavior monitoring system is referred to by the reference numeral 100 and includes a vehicle 105, such as an automobile, and a vehicle control unit 110 located on the vehicle 105. The vehicle 105 may include a front portion 115a (including a front bumper), a rear portion 115b (including a rear bumper), a right side portion 115c (including a right front quarter panel, a right front door, a right rear door, and a right rear quarter panel), a left side portion 115d (including a left front quarter panel, a left front door, a left rear door, and a left rear quarter panel), and wheels 115e. A communication module 120 is operably coupled to, and adapted to be in communication with, the vehicle control unit 110. The communication module 120 is adapted to communicate wirelessly with a central server 125 via a network 130 (e.g., a 3G network, a 4G network, a 5G network, a Wi-Fi network, or the like). The central server 125 may provide information and services including but not limited to include location, mapping, route or path, and topography information.

An operational equipment engine 140 is operably coupled to, and adapted to be in communication with, the vehicle control unit 110. A sensor engine 150 is operably coupled to, and adapted to be in communication with, the vehicle control unit 110. The sensor engine 150 is adapted to monitor various components of, for example, the operational equipment engine 140, as will be described in further detail below. An interface engine 155 is operably coupled to, and adapted to be in communication with, the vehicle control unit 110. In addition to, or instead of, being operably coupled to, and adapted to be in communication with, the vehicle control unit 110, the communication module 120, the operational equipment engine 140, the sensor engine 150, and/or the interface engine 155 may be operably coupled to, and adapted to be in communication with, another of the components via wired or wireless communication (e.g., via an in-vehicle network). In some examples, the vehicle control unit 110 is adapted to communicate with the communication module 120, the operational equipment engine 140, the sensor engine 150, and the interface engine 155 to at least partially control the interaction of data with and between the various components of the vehicle occupant behavior monitoring system 100.

The term “engine” is meant herein to refer to an agent, instrument, or combination of either, or both, agents and instruments that may be associated to serve a purpose or accomplish a task-agents and instruments may include sensors, actuators, switches, relays, power plants, system wiring, computers, components of computers, programmable logic devices, microprocessors, software, software routines, software modules, communication equipment, networks, network services, and/or other elements and their equivalents that contribute to the purpose or task to be accomplished by the engine. Accordingly, some of the engines may be software modules or routines, while others of the engines may be hardware and/or equipment elements in communication with any or all of the vehicle control unit 110, the communication module 120, the network 130, or a central server 125.

In this example, the vehicle 105 also includes a chassis electronic control unit (ECU) 111 which controls elements of the vehicle's suspension system, a brake ECU 112 which controls the braking system or elements thereof, a power train ECU 113 (variously known as an engine ECU, power plant ECU, motor ECU, or transmission ECU) that controls elements of the motor 195 and drivetrain 200, sensor engine 150, and an occupant behavior monitoring engine 142, the operation of which will be described below.

A reader of ordinary skill in the art will understand that other components or arrangements of components may be found in a vehicle 105, and that the same general principles apply to electric vehicles, internal combustion vehicles, and hybrid vehicles. For example, a power train ECU 113 may control both motor and transmission components. Alternatively, a separate motor ECU and transmission ECU may exist, or some functions of a motor ECU or transmission ECU may be performed by the VCU 110.

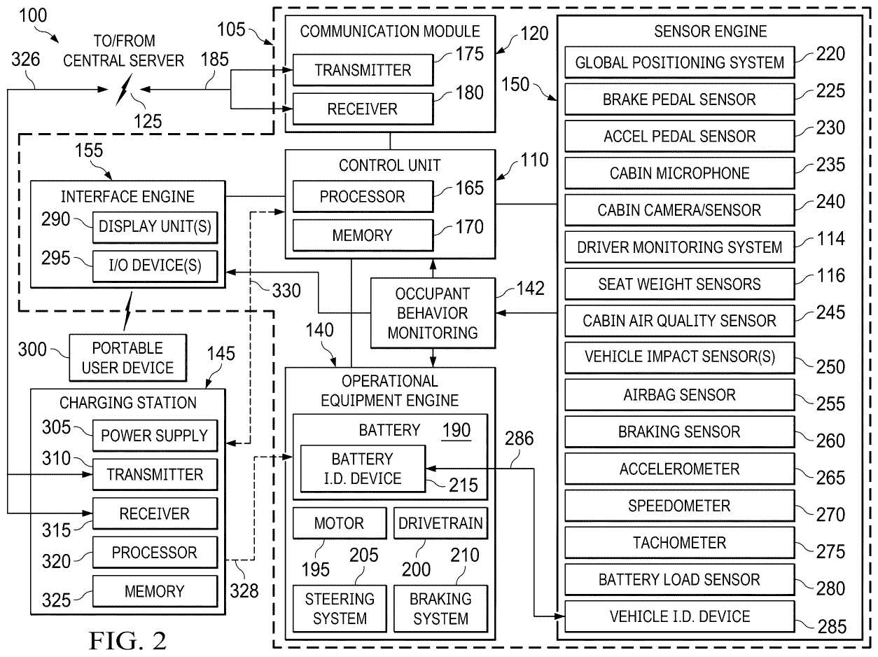

FIG. 2 is a diagrammatic illustration, in a block-diagram form, of at least a portion of the vehicle occupant behavior monitoring system 100 of FIG. 1, in accordance with at least one embodiment of the present disclosure. It is worth noting that the components of the vehicle 105 may be located either permanently or temporarily as a part of the vehicle 105. The vehicle control unit (VCU) 110 includes a processor 165 and a memory 170. In some examples, the communication module 120, which is operably coupled to, and adapted to be in communication with, the vehicle control unit 110, includes a transmitter 175 and a receiver 180. In some examples, one or the other of the transmitter 175 and the receiver 180 may be omitted according to the particular application for which the communication module 120 is to be used. In other examples, the transmitter 175 and receiver 180 are combined into a single transceiver that performs both transmitting and receiving functions.

In some examples, the operational equipment engine 140, which is operably coupled to, and adapted to be in communication with, the vehicle control unit 110, includes a plurality of devices configured to facilitate driving of the vehicle 105. In this regard, the operational equipment engine 140 may be designed to exchange communication with the vehicle control unit 110, so as to not only receive instructions, but to provide information on the operation of the operational equipment engine 140. For example, the operational equipment engine 140 may include a vehicle battery 190, a motor 195, a drivetrain 200, a steering system 205, and a braking system 210. In some vehicles, the vehicle battery 190 may provide electrical power to the motor 195 to drive the wheels 115e of the vehicle 105 via the drivetrain 200. In some examples, instead of or in addition to providing power to the motor 195 to drive the wheels 115e of the vehicle 105 via the drivetrain or transmission 200, the vehicle battery 190 provides electrical power to another component of the operational equipment engine 140, the vehicle control unit 110, the communication module 120, the sensor engine 150, the interface engine 155, or any combination thereof. In some examples, the vehicle battery 190 includes a battery identification device 215. The battery identification device 215 is adapted to communicate with one or more components of the sensor engine 150, and stores data identifying the vehicle battery 190 such as, for example, manufacturing information (e.g., production date, production facility, etc.), battery characteristic(s) information, battery identification number information, electric vehicle compatibility information, or the like. In some embodiments, the motor is an internal combustion motor and the battery operates a starter.

In some examples, the sensor engine 150, which is operably coupled to, and adapted to be in communication with, the vehicle control unit 110, includes devices such as sensors, meters, detectors, or other devices configured to measure or sense a parameter related to a driving operation of the vehicle 105. For example, the sensor engine 150 may include a global positioning system 220 that can be used to determine road grade, a brake pedal sensor 225, an accelerator pedal sensor 230, a cabin microphone 235 that can be used to determine the sound level within the cabin, cabin camera or sensor 240 that can be used to determine the pose of a driver's upper leg and lower leg, a cabin air quality sensor 245, a vehicle impact sensor 250, an airbag sensor 255, a braking sensor 260, an accelerometer 265 (which may in some cases also serve as an inclinometer), a speedometer 270, a tachometer 275, a battery load sensor 280, a vehicle identification device 285, a driver monitoring system 114 that can be used to track the identity and limb positions/angles of the driver, a seat weight sensor 116 that can be used to determine whether a given seat is occupied, or any combinations thereof. In some instances, traffic or weather patterns may be monitored from outside the vehicle and received from a server via a network.

The sensors or other detection devices may be configured to sense or detect activity, conditions, and circumstances in an area to which the device has access, e.g., ambient conditions, conditions within the vehicle cabin, conditions within the driver's side foot well, etc.. Sub-components of the sensor engine 150 may be deployed at any operational area where information on the driving of the vehicle 105 may occur. Some readings from the sensor engine 150 may be fed back to the vehicle control unit 110. Stored and reported performance data may include the sensed data, or may be derived, calculated, or inferred from sensed data. The vehicle control unit 110 may send signals to the sensor engine 150 to adjust the calibration or operating parameters of the sensor engine 150 in accordance with a control program in the vehicle control unit 110. The vehicle control unit 110 is adapted to receive and process performance data from the sensor engine 150 or from other suitable source(s), and to monitor, store (e.g., in the memory 170), and/or otherwise process (e.g., using the processor 165) the received performance data.

The braking sensor 260 is adapted to monitor usage of the vehicle 105's braking system 210 (e.g., an antilock braking system 210) and to communicate the braking information to the vehicle control unit 110. The accelerometer 265 is adapted to monitor acceleration of the vehicle 105 and to communicate the acceleration information to the vehicle control unit 110. The accelerometer 265 may be, for example, a two-axis accelerometer 265 or a three-axis accelerometer 265, and may also serve as an inclinometer or tilt sensor. In some examples, the accelerometer 265 is associated with an airbag of the vehicle 105 to trigger deployment of the airbag. The speedometer 270 is adapted to monitor speed of the vehicle 105 and to communicate the speed information to the vehicle control unit 110. In some examples, the speedometer 270 is associated with a display unit of the vehicle 105 such as, for example, a display unit of the interface engine 155, to provide a visual indication of vehicle speed to a driver of the vehicle 105. The tachometer 275 is adapted to monitor the working speed (e.g., in revolutions-per-minute) of the vehicle 105's motor 195 and to communicate the angular velocity information to the vehicle control unit 110. In some examples, the tachometer 275 is associated with a display unit of the vehicle 105 such as, for example, a display unit of the interface engine 155, to provide a visual indication of the motor 195's working speed to the driver of the vehicle 105. The battery load sensor 280 is adapted to monitor charging, discharging, and/or overcharging of the vehicle battery 190 and to communicate the charging, discharging, and/or overcharging information to the vehicle control unit 110.

In some examples, the vehicle identification device 285 stores data identifying the vehicle 105 such as, for example, manufacturing information (e.g., make, model, production date, production facility, etc.), vehicle characteristic(s) information, vehicle identification number (“VIN”) information, battery compatibility information, or the like. The vehicle identification device 285 is adapted to communicate with the battery identification device 215 (or vice versa), as indicated by arrow 286. In some examples, the vehicle identification device 285 and the battery identification device 215 may each communicate with the vehicle control unit 110.

In some examples, the interface engine 155, which is operably coupled to, and adapted to be in communication with, the vehicle control unit 110, includes at least one input and output device or system that enables a user to interact with the vehicle control unit 110 and the functions that the vehicle control unit 110 provides. For example, the interface engine 155 may include a display unit 290 and an input/output (“I/O”) device 295. The display unit 290 may be, include, or be part of multiple display units. In some examples, the display unit 290 may include one, or any combination, of a central display unit associated with a dash of the vehicle 105, an instrument cluster display unit associated with an instrument cluster of the vehicle 105, and/or a heads-up display unit associated with the dash and a windshield of the vehicle 105; accordingly, as used herein the reference numeral 290 may refer to one, or any combination, of the display units. The I/O device 295 may be, include, or be part of a communication port (e.g., a USB port), a Bluetooth communication interface, a touch-screen display unit, soft keys associated with a dash, a steering wheel, or another component of the vehicle 105, and/or similar components. Other examples of sub-components that may be part of the interface engine 155 include, but are not limited to, audible alarms, visual alerts, telecommunications equipment, and computer-related components, peripherals, and systems.

In some examples, a portable user device 300 belonging to an occupant of the vehicle 105, or to a parent/guardian at a remote location, may be coupled to, and adapted to be in communication with, the interface engine 155. For example, the portable user device 300 may be coupled to, and adapted to be in communication with, the interface engine 155 via the I/O device 295 (e.g., a cellular communication interface). In some examples, the portable user device 300 is, includes, or is part of one or more computing devices such as personal computers, personal digital assistants, cellular devices, mobile telephones, wireless devices, handheld devices, laptops, audio devices, tablet computers, game consoles, cameras, and/or any other suitable devices. In several examples, the portable user device 300 is a smartphone such as, for example, an iPhone® by Apple Incorporated.

The vehicle occupant behavior monitoring system 100 also includes occupant behavior monitoring engine 142, the operation of which will be described below. In some embodiments, the occupant behavior monitoring engine 142 comprises a standalone housing and/or chipset with its own processor and memory. In other embodiments, the acceleration compensation engine exists as software, firmware, or hardware within another processor, such as the vehicle control unit 110, operational equipment engine 140, or brake ECU 112. The occupant behavior monitoring engine 142 may be in communication with one or more of the sensor engine 150, VCU 110, operational equipment engine 140, or interface engine 155.

The sensor engine 150 includes environmental sensors and vehicle sensors.

A reader of ordinary skill in the art will understand that other components or arrangements of components may be found in a vehicle 105, and that may of the same general principles apply to electric vehicles, internal combustion vehicles, and hybrid vehicles.

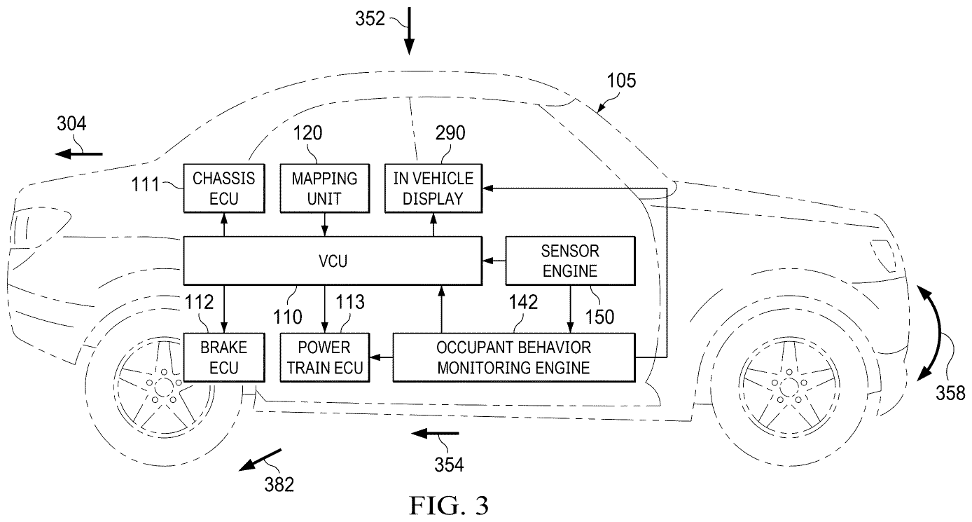

FIG. 3 is an exemplary diagrammatic illustration of the vehicle occupant behavior monitoring system 100 embodied as a vehicle 105 in accordance with at least one embodiment of the present disclosure. In this implementation, for clarity, only certain engines, systems, and components are shown. However, other engines, systems, and components, including those describe herein, are also contemplated as being a part of the vehicle occupant behavior monitoring system 100 shown in FIG. 3. In this example, within the vehicle 105 the VCU 110 receives information from a sensor engine 150, which receives information from environmental sensors and vehicle sensors. In addition, the VCU 110 sends information to the chassis ECU 111, brake ECU 112, power train ECU 113, and in-vehicle display 290.

Force variables that may be incorporated into physics calculations within the VCU 110, occupant behavior monitoring engine 142, or other engines include but are not limited to the vehicle absolute weight 352, vehicle rolling friction 354, vehicle aerodynamic drag 304, and vehicle pitch 358. In some examples, each of these variables is a force that may be expressed in lbf, Newtons, degrees, or any other unit as needed. In an example, the vehicle pitch 358 is stored within the memory 170 of the Vehicle Control Unit 110, and is calculated based on data from the accelerometer 265 to provide a sensed acceleration, and the first derivative of the vehicle speed 270 from the speedometer 270 to provide an acceleration value tangent or parallel to the road surface. The difference between these two acceleration vectors can indicate vehicle pitch 358. Vehicle pitch may also be measured with an inclinometer or geomagnetometer.

Other variables may not be directly known, but may be estimated from graphs, curves, or lookup tables for a nominal vehicle (e.g., vehicle weight 352, vehicle rolling friction 354, and vehicle aerodynamic drag 304). Some variables may be calculated or estimated from performance variables that normally exist within the VCU 110. For example, the combined mass, gross weight, or inertia of the vehicle 105 may be determined from the acceleration profile of the vehicle given a known force imparted by the motor 195 and drivetrain 200, and the Newtonian relationship F=ma. The mass of the carried load may then be estimated by subtracting a nominal or expected vehicle mass (e.g., stock weight or stock mass). Alternatively, if the road grade is known (e.g., from GPS data), the combined vehicle and carried load mass may be estimated based on the work or energy required for the operational equipment engine to push the vehicle uphill, or the force required hold it from rolling backward.

The total drag on the vehicle can be calculated based on the power output required to maintain a particular vehicle speed 270, and the sum of nominal or estimated values of the vehicle rolling friction 354 and aerodynamic drag 304. The ratio of aerodynamic drag to rolling friction can be estimated from known relationships for typical vehicles, or by other methods. The grade of the road or ground surface under the vehicle may be calculated from accelerometers, or may be calculated or taken directly from stored maps, GPS data or other indicators. The combination of vehicle weight 352, vehicle aerodynamic drag 304, and vehicle rolling friction 354 can be used to compute a vehicle rolling resistance vector 382 (e.g., as a vector sum of the force vectors). Histories, time averages, first derivatives, integrals, or filters of any of the aforementioned variables, along with known, anticipated, or estimated future values for some or all of the variables may also be incorporated into the physics calculations to improve or refine the results of the calculations. Accelerator pedal position may also be incorporated as being proportional to an expected power output from the motor 195.

The vehicle occupant behavior monitoring system 100 also includes an occupant behavior monitoring engine 142, which accepts inputs from the sensor engine (e.g., inputs from the cabin microphone 235, cabin air quality sensor 245, cabin camera/sensor 240, driver monitoring system 114, and seat weight sensors 116) and provides outputs, for example, to the in-vehicle display 290.

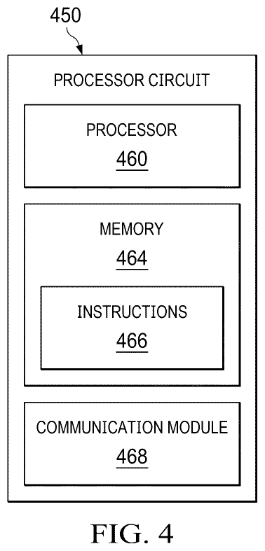

FIG. 4 is a schematic diagram of a processor circuit 450, in accordance with at least one embodiment of the present disclosure. The processor circuit 450 may be implemented in the system 100, or other devices or workstations (e.g., third-party workstations, network routers, etc.), or on a cloud processor or other remote processing unit, as necessary to implement the method. As shown, the processor circuit 450 may include a processor 460, a memory 464, and a communication module 468. These elements may be in direct or indirect communication with each other, for example via one or more buses.

The processor 460 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 460 may also comprise another hardware device, a firmware device, or any combination thereof configured to perform the operations described herein. The processor 460 may also be implemented as a combination of computing devices, e.g., a combination of a DSP and a microprocessor, a plurality of microprocessors, one or more microprocessors in conjunction with a DSP core, or any other such configuration.

The memory 464 may include a cache memory (e.g., a cache memory of the processor 460), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 464 includes a non-transitory computer-readable medium. The memory 464 may store instructions 466. The instructions 466 may include instructions that, when executed by the processor 460, cause the processor 460 to perform the operations described herein. Instructions 466 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 468 can include any electronic circuitry and/or logic circuitry to facilitate direct or indirect communication of data between the processor circuit 450, and other processors or devices. In that regard, the communication module 468 can be an input/output (I/O) device. In some instances, the communication module 468 facilitates direct or indirect communication between various elements of the processor circuit 450 and/or the system 100. The communication module 468 may communicate within the processor circuit 450 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or readings from vehicle or environmental sensors) may be accomplished using any suitable wireless or wired communication technology, such as a cable interface such as a universal serial bus (USB), micro USB, Lightning, or Fire Wire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

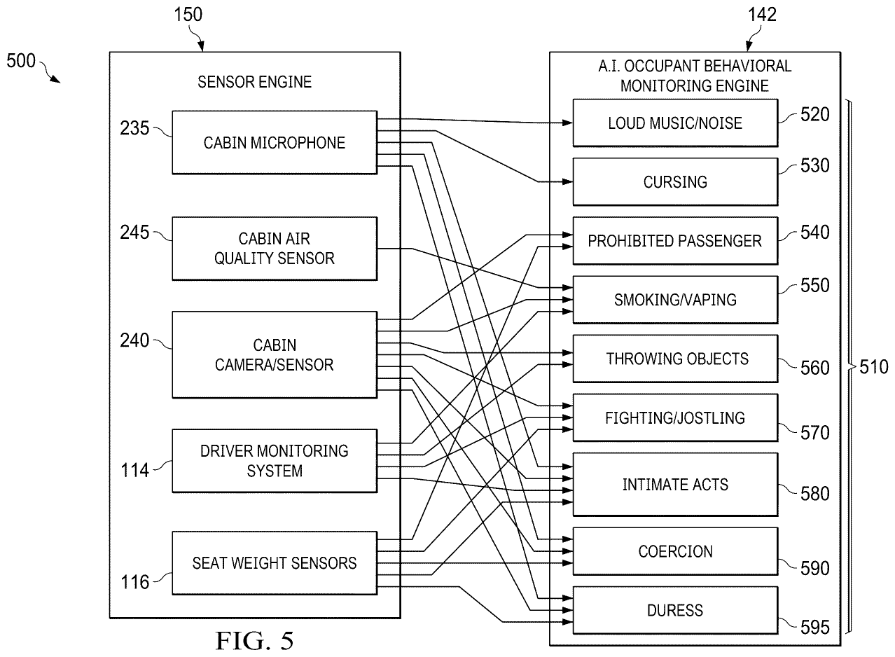

FIG. 5 is a graphical representation of at least a portion of an example vehicle occupant behavior monitoring system 500, in accordance with at least one embodiment of the present disclosure. In the example shown in FIG. 5, the sensor engine 150 includes a cabin microphone 235, cabin air quality sensor 245, cabin camera or sensor (e.g., lidar) 240, driver monitoring system 114 (which may also include a camera or sensor such as a lidar), and seat weight sensors 116. The vehicle occupant behavior monitoring system 500 includes an artificial intelligence (AI) vehicle occupant behavioral monitoring engine 142 (e.g., a custom chipset), which is configured to detect and respond to a number of prohibited non-driving behaviors 510. The prohibited behaviors include loud music or noise 520, cursing 530, one or more prohibited passengers 540, smoking or vaping 550, throwing objects 560, fighting or jostling 570, intimate acts 580, coercion 590 from the passenger and finally the passenger causing duress 595 to the driver.

Loud music or noise 520 may for example be detected by sampling the cabin microphone 235 and simply measuring the sound level (e.g., in decibels (dB)). Any sound level exceeding a threshold sound level (e.g., 70 dB) may be considered loud and therefore prohibited. Similarly, cursing 530 may be detected by sampling the cabin microphone 235 and performing automatic speech recognition (ASR) to identify prohibited keywords.

One or more prohibited passengers 540 may also be detected. In some cases, a driver may not be allowed to carry any passengers at all. In such cases, the seat weight sensors 116 may be sufficient to determine that one or more passengers are present. In other cases, a driver may not be allowed to transport a particular “problem friend”, in which case the cabin camera or sensor may be used to collect images, on which the AI vehicle occupant behavioral monitoring engine 142 performs facial recognition (FR) to identify that the prohibited passenger is in the vehicle.

Smoking or vaping 550 may be detected by the cabin air quality sensor 245, and/or by performing image recognition on images captured by the cabin camera or sensor 240 and/or the driver monitoring system 114. Similarly, throwing objects 560 can be detected using image recognition on images captured by the cabin camera or sensor 240 and/or the driver monitoring system 114. In some cases, fighting or jostling 570 may also be detected using image recognition on images captured by the cabin camera or sensor 240 and/or the driver monitoring system 114. In other cases, fighting or jostling 570 may be detected by changes in the weight sensed by one or more seat weight sensors 116. In such cases, a pattern of increases and decreases in sensed driver or passenger weight may be recognized as indicative of fighting or jostling. Detection of intimate acts 580, coercion 590 and duress 595 may be similar to detection of fighting or jostling 570, with the addition that the cabin microphone 235 may be used as an additional detection input. Using speech recognition, the AI guardian could determine if the passenger is being coercive to the driver. The scenario may be that the passenger is not identified as a prohibited person but could become a bad influence, so AI could be used to recognize if they are asking the driver to drive faster, run through lights, etc. In this way, the guardian can then be informed and then act (remedial action, add to “prohibited” friends list, etc.). Taking this one step further, the passenger may cause duress (e.g., potentially a kidnapping situation), and the AI recognition can inform the guardian and potentially go further to activate GPS location tracking and send to the police.

In addition to identifying a prohibited behavior in a binary sense of behavior present/behavior not present, the vehicle occupant behavior monitoring system may also assign a severity score to each detected behavior, such as a value between 1 and 10. Such a severity score may help the system gauge which curtailment action(s) to use as a response, and/or how strongly to apply one or more curtailment actions. A person of ordinary skill in the art will appreciate that other prohibited behaviors may be defined and detected, instead of or in addition to those described above.

Depending on the implementation, the AI vehicle occupant behavioral monitoring engine 142 may rely on classical image/sound recognition algorithms, or may be or include one or more machine learning algorithms (e.g., classifiers, perceptrons, etc.) that receive raw or processed inputs from the sensor engine 150 and output detections of the prohibited non-driving behaviors 510. Processing of the inputs may for example include noise filtering, highpass and/or lowpass filtering, analog-to-digital conversion, etc.

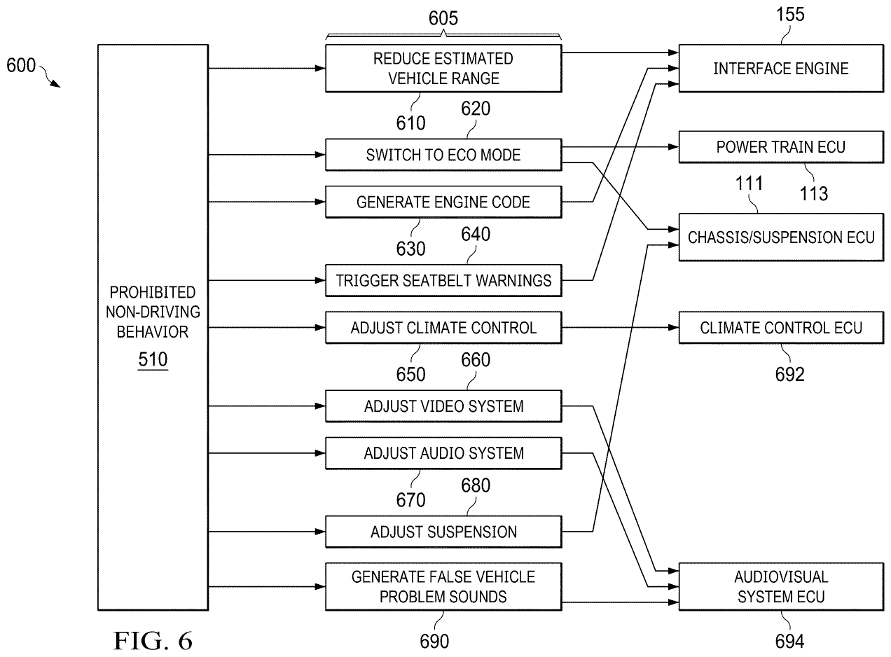

FIG. 6 is a is a graphical representation of at least a portion of an example vehicle occupant behavior monitoring system 600, in accordance with at least one embodiment of the present disclosure. In the example shown in FIG. 6, the AI vehicle occupant behavioral monitoring engine has detected one or more prohibited non-driving behaviors 510, and will undertake one or more curtailment actions 605 in response. Curtailment actions 605 may for example include reducing the vehicle estimated range 610, switching the vehicle to Eco mode 620, generating a false engine code 630, triggering seatbelt warnings 640, adjusting climate control 650, adjusting the video system 660, adjusting the audio system 670, adjusting the vehicle suspension 680, and generating false vehicle problem sounds 690.

In an example, reducing the vehicle estimated range 610 may involve sending false inputs to the interface engine 155. Switching to Eco mode 620 (e.g., from Sport mode) may involve sending commands to the power train ECU 113 and/or the chassis ECU or suspension ECU 111. Eco mode may for example reduce acceleration and/or make the vehicle suspension less stiff. Generating a false engine code 630 (e.g., a non-critical warning icon on the dashboard) or a false periodic seatbelt warning 640 may for example involve sending a false signal or message to the interface engine 155.

Adjusting the climate control 650 may involve sending a signal or message to the climate control ECU 692.

Adjusting the video system may for example involve degrading the quality of displayed video, or turning off video displays, by sending a signal or message to the audiovisual system ECU 694. Adjusting the audio system (e.g., to decrease audio volume or turn off audio) may similarly involve sending a signal or message to the audiovisual system ECU 694. Generating false vehicle engine problem sounds may also involve sending a signal, message, pattern, or file to the audiovisual system ECU 694.

Adjusting the suspension 680 (e.g., to give the vehicle a stiffer or looser response) may for example involve sending a signal to the cassis ECU or suspension ECU 111.

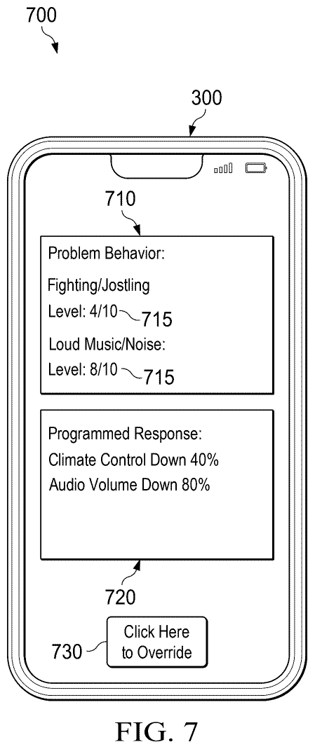

FIG. 7 is a pre-curtailment screen display 700 for an example vehicle occupant behavior monitoring system, in accordance with at least one embodiment of the present disclosure. The screen display 700 may for example be displayed on a mobile device 300 of a parent or guardian of a teenage driver. In the example shown in FIG. 7, the screen display 700 includes a problem behavior reporting window 710, a programmed response window 720, and an override button 730.

The problem behavior reporting window 710 may for example display, in real time, the names and severity scores 715 of prohibited behaviors which the vehicle occupant behavior monitoring system has detected. The programmed response window 720 may for example display, in real time, the curtailment actions that will be taken to mitigate the prohibited behavior. Such programmed responses may be default settings of the vehicle occupant behavior monitoring system, and/or may be customized with inputs from the parent or guardian. For example, a parent or guardian may decide that loud music or noise will be curtailed by reducing the volume of the audio system, in direct proportion to how loud it currently is, and may decide that fighting or jostling will be curtailed by reducing the cabin temperature, or increasing the fan speed, in proportion to how serious the fighting/jostling is.

The override button 730 may allow the parent or guardian to halt the programmed response, and for example substitute it with a manually selected curtailment response, or with a telephone call to the driver.

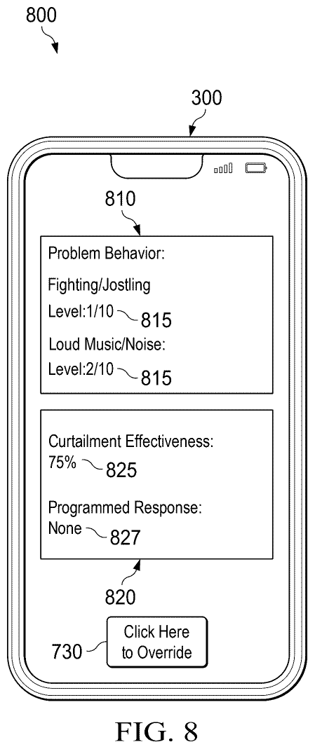

FIG. 8 is a post-curtailment screen display 800 for an example vehicle occupant behavior monitoring system, in accordance with at least one embodiment of the present disclosure. The screen display 800 may for example be displayed on a mobile device 300 of a parent or guardian of a teenage driver. In the example shown in FIG. 8, the screen display 800 includes a problem behavior reporting window 810, a curtailment effectiveness and programmed response window 820, and an override button 730.

The problem behavior reporting window 810 may for example display, in real time, the names and severity scores of prohibited behaviors which the vehicle occupant behavior monitoring system has previously detected (e.g., pre-curtailment), and their current, real-time, post-curtailment severity scores 815. In general, it may be expected or desired that in response to the curtailment actions, the severity of prohibited behaviors will reduce to a lower number (e.g., 0-2 on a scale of 1-10). Thus, the problem behavior reporting window 810 may be used to show improvement in the prohibited behaviors.

The curtailment effectiveness and programmed response window 820 may for example display a curtailment effectiveness 825 computed by the vehicle occupant behavior monitoring system. This curtailment effectiveness may for example be a percentage, calculated as an average reduction in all of the detected problem behaviors. The curtailment effectiveness and programmed response window 820 may also display a post-curtailment programmed response 827, which may for example be less severe than the original curtailment action, or may involve no curtailment at all.

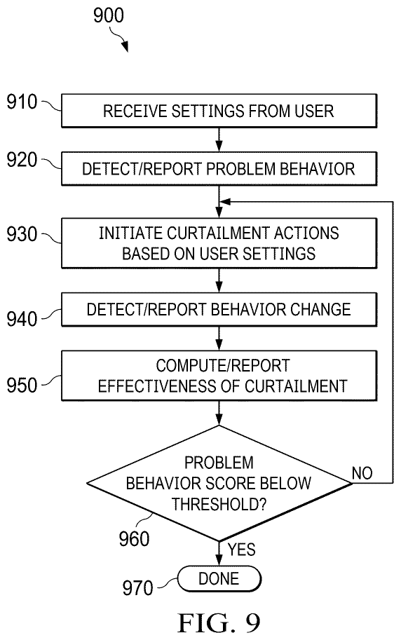

FIG. 9 is a schematic, diagrammatic representation, in flow diagram form, of an example vehicle occupant behavior monitoring method 900, in accordance with at least one embodiment of the present disclosure. It is understood that the blocks of method 900 may be performed in a different order than shown in FIG. 9, additional blocks can be provided before, during, and after the blocks, and/or some of the blocks described can be replaced or eliminated in other embodiments. One or more of blocks of the method 900 can be carried by one or more devices and/or systems described herein, such as components of the system 100, system 500, system 600, and/or processor circuit 450.

In block 910, the method 900 includes receiving settings from the user. The settings may for example include the selection of curtailment responses and response levels for each prohibited non-driving behavior. In some cases, the user may select a single curtailment response or set of curtailment responses that apply regardless of which prohibited behaviors are detected. In other cases, the user may simply confirm a set of default responses programmed into the vehicle occupant behavior monitoring system. Execution then proceeds to block 920.

In block 920, the method 900 includes detecting and reporting problem behaviors as described above in FIGS. 5 and 7. Execution then proceeds to block 930.

In block 930, the method 900 includes initiating one or more curtailment actions based on the user settings, the detected behaviors, and the severity of the detected behaviors, as described above in FIG. 6. Execution then proceeds to block 940.

In block 940, the method 900 includes detecting and reporting on any changes in the detected problem behavior, as described above in FIG. 8. Execution then proceeds to block 950.

In block 950, the method 900 includes computing and reporting the effectiveness of the curtailment, as described above in FIG. 8. Execution then proceeds to block 960.

In block 960, the method 900 includes determining whether each problem behavior score is below a defined threshold for a further curtailment response. If no, execution returns to block 930. If yes, execution proceeds to block 970.

In block 970, the method 900 is complete.

Flow diagrams are provided herein for exemplary purposes; a person of ordinary skill in the art will recognize myriad variations that nonetheless fall within the scope of the present disclosure. For example, any of the blocks described herein may optionally include an output to a user of information relevant to the block, and may thus represent an improvement in the user interface over existing art by providing information (whether static or dynamically updated) that is not otherwise available. Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the blocks described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein.

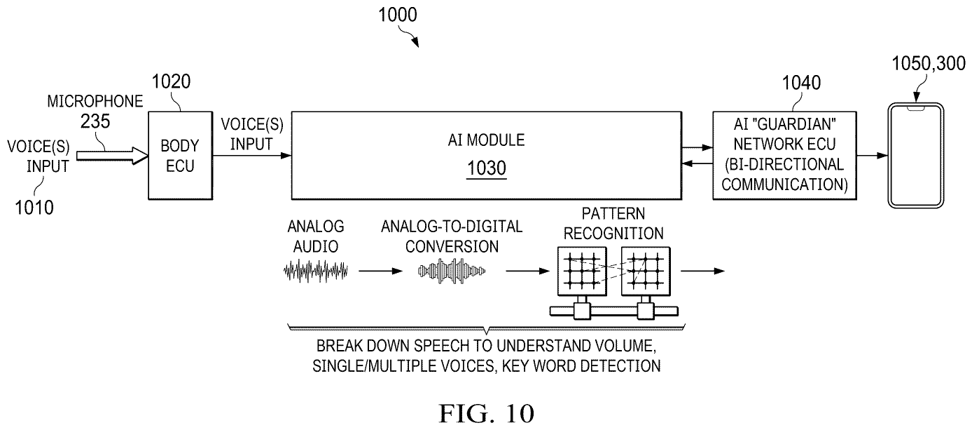

FIG. 10 is a schematic, diagrammatic representation of a curse word detection and reporting subsystem 1000 of the vehicle occupant behavior monitoring system, in accordance with at least one embodiment of the present disclosure. In the example shown in FIG. 10, voice input 1010 via the microphone 235 is received by a body ECU 1020 and passed to an AI module 1030, which converts analog audio to digital audio via analog-to-digital conversion, and uses pattern recognition to break down speech to understand speech volume, single vs. multiple voices, and perform keyword detection. Outputs of the AI module 1030 are then received by an AI parent/guardian network ECU 1040 (e.g., via bi-directional communication), which runs on or communicates with an application 1050 on the parent/guardian mobile device 300.

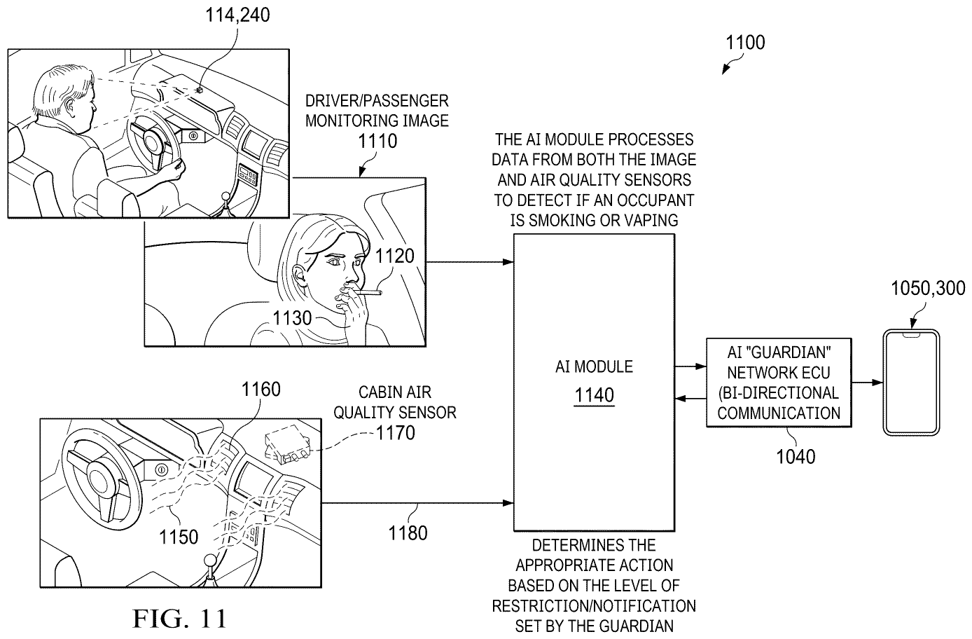

FIG. 11 is a schematic, diagrammatic representation of a smoking/vaping detection and reporting subsystem 1100 of the vehicle occupant behavior monitoring system, in accordance with at least one embodiment of the present disclosure. In the example shown in FIG. 11, the driver monitoring system camera 114, or a cabin camera or cabin sensor 240, generates an image 1110 of the driver or a passenger. The image 1110 may for example include a cigarette, cigar, pipe, vape pen, or other smoking/vaping apparatus 1120, as well as hand-to-mouth motions 1130 indicative of smoking or vaping. The image 1110 is then received by an AI module 1140.

In addition, smoke or vapor 1150 that circulates through the air conditioning vents 1160 can be detected by a cabin air quality sensor 1170, which passes a signal 1180 to the AI module 1140. Based on the image 1110 and the cabin air quality signal 1180, the AI module is able to detect whether smoking/vaping is occurring in the vehicle, and if so, to pass this information along to the AI guardian network ECU, for transmission to the app 1050 running on the parent/guardian mobile device 300.

As will be readily appreciated by those having ordinary skill in the art after becoming familiar with the teachings herein, the vehicle occupant behavior monitoring system advantageously detects prohibited non-driving behaviors and warns the driver via curtailment actions, and also warns a parent or guardian, informs the parent/guardian about the curtailment actions, and gives the parent/guardian an opportunity to change curtailment actions manually. Accordingly, it can be seen that the vehicle occupant behavior monitoring system fills a need in the art, by allowing drivers to avoid an unsafe situation (e.g., engaging in unsafe non-driving behaviors while the vehicle is in motion).

A number of variations are possible on the examples and embodiments described above. For example, other problem behaviors may be detected and responded to than those listed herein. Other curtailment actions may be taken, including but not limited to automatic text or verbal warnings.

The technology described herein may be implemented on manually controlled vehicles or driver-assist vehicles. The technology may be implemented in diverse combinations of hardware, software, and firmware, depending on the implementation or as necessitated by the structures and modules already present in existing vehicles. The system may be employed on vehicles with automatic transmission, manual transmissions, or vehicles with simulated shifting, including continuously variable transmission (CVT), infinitely variable transmission (IVT), hybrid transmissions (e.g., a hybrid vehicle with 4-speed automatic transmission simulating 10 gears), and fully electric vehicles.

Accordingly, the logical operations making up the embodiments of the technology described herein may be referred to variously as operations, steps, blocks, objects, elements, components, or modules. Furthermore, it should be understood that these may occur or be arranged in any order, unless explicitly claimed otherwise or a specific order is necessitated by the claim language or by the nature of the component or step.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the vehicle occupant behavior monitoring system. Connection references, e.g., attached, coupled, connected, and joined are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” Unless otherwise noted in the claims, stated values shall be interpreted as illustrative only and shall not be taken to be limiting.

The above specification, examples and data provide a complete description of the structure and use of exemplary embodiments of the vehicle occupant behavior monitoring system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter. For example, additional sensors may be employed. Additionally, sensors external to the vehicle may be employed to provide or supplement any of the sensor data described hereinabove. Alternatively, machine learning algorithms or other AI systems may be used to estimate variables from sparse, noisy, or entwined data streams without departing from the spirit of the present disclosure.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

1. A vehicle occupant behavior monitoring system, the system comprising:
the vehicle;
at least one sensor;
a processor comprising a memory and configured to:
with the at least one sensor, capture first information about a prohibited non-driving behavior of an occupant of the vehicle;
based on the captured first information, determine a first severity of the prohibited non-driving behavior;
based on the prohibited non-driving behavior and the determined first severity, automatically initiate a curtailment action, wherein a magnitude of the curtailment action is based on the determined first severity;
with the at least one sensor, capture second information about the prohibited non-driving behavior of the occupant of the vehicle;
based on the captured second information, determine a second severity of the prohibited non-driving behavior;
based on the second severity, adjust the magnitude of the curtailment action; and
report at least one of the prohibited non-driving behavior, the first severity, the second severity, or the curtailment action to a device operated by a parent or guardian of the occupant of the vehicle.

2. (canceled)

3. The system of claim 1, wherein automatically initiating a curtailment action requires first receiving an input from the parent or guardian of the driver of the vehicle regarding a relationship between severity of the prohibited non-driving behavior and magnitude of the curtailment action.

4. The system of claim 1, wherein the at least one sensor comprises a microphone, and the prohibited non-driving behavior comprises loud noise, yelling, or cursing.

5. The system of claim 1, wherein the at least one sensor comprises a cabin lidar or a seat weight sensor, and the prohibited non-driving behavior comprises transporting a prohibited passenger.

6. The system of claim 1, wherein the at least one sensor comprises a cabin lidar, or a cabin air quality sensor, and the prohibited non-driving behavior comprises smoking or vaping.

7. The system of claim 1, wherein the at least one sensor comprises a cabin lidar, and the prohibited non-driving behavior comprises throwing objects.

8. The system of claim 1, wherein the at least one sensor comprises a cabin lidar or a seat weight sensor, and the prohibited non-driving behavior comprises fighting or jostling.

9. The system of claim 1, wherein the at least one sensor comprises a cabin lidar, or a seat weight sensor, and the prohibited non-driving behavior comprises an intimate act, coercion, or duress.

10. The system of claim 1, wherein the curtailment action comprises at least one of reducing an estimated vehicle range, switching to an Eco mode, generating an engine code, triggering seatbelt warnings, adjusting climate control, adjusting a video system, adjusting a suspension of the vehicle, or generating false vehicle problem sounds.

11. A computer-implemented method for monitoring vehicle occupant behavior, the method comprising:
with a processor comprising a memory:
with at least one sensor, capturing first information about a prohibited non-driving behavior of an occupant of the vehicle;
based on the captured first information, determining a first severity of the prohibited non-driving behavior;
based on the prohibited non-driving behavior and the determined first severity, automatically initiating a curtailment action, wherein a magnitude of the curtailment action is based on the determined first severity;
with the at least one sensor, capturing second information about the prohibited non-driving behavior of the occupant of the vehicle;
based on the captured second information, determining a second severity of the prohibited non-driving behavior;
based on the second severity, adjusting the magnitude of the curtailment action; and
report at least one of the prohibited non-driving behavior, the first severity, the second severity, or the curtailment action to a device operated by a parent or guardian of the occupant of the vehicle.

12. (canceled)

13. The method of claim 11, wherein automatically initiating a curtailment action requires first receiving an input from the parent or guardian of the driver of the vehicle regarding a relationship between severity of the prohibited non-driving behavior and magnitude of the curtailment action.

14. The method of claim 11, wherein the at least one sensor comprises a microphone, and the prohibited non-driving behavior comprises loud noise, or cursing.

15. The method of claim 11, wherein the at least one sensor comprises a cabin lidar or a seat weight sensor, and the prohibited non-driving behavior comprises transporting a prohibited passenger.

16. The method of claim 11, wherein the at least one sensor comprises a cabin lidar, or a cabin air quality sensor, and the prohibited non-driving behavior comprises smoking or vaping.

17. The method of claim 11, wherein the at least one sensor comprises a cabin lidar, and the prohibited non-driving behavior comprises throwing objects.

18. The method of claim 11, wherein the at least one sensor comprises a cabin lidar or a seat weight sensor, and the prohibited non-driving behavior comprises fighting or jostling.

19. The method of claim 11, wherein the at least one sensor comprises a cabin lidar, or a seat weight sensor, and the prohibited non-driving behavior comprises an intimate act, coercion, or duress.

20. The method of claim 11, wherein the curtailment action comprises at least one of reducing an estimated vehicle range, switching to an Eco mode, generating an engine code, triggering seatbelt warnings, adjusting climate control, adjusting a video system, adjusting a suspension of the vehicle, or generating false vehicle problem sounds.
